(19) United States
(12) Patent Application Publication
(10) Pub. No.: US 2021/0197805 A1
(43) Pub. Date: Jul. 1, 2021

(54) SAFETY SYSTEM FOR VEHICLE

(71) Applicant: Motional AD LLC, Boston, MA (US)

(72) Inventors: Philipp Robbel, Cambridge, MA (US); Paul Schmitt, Merrimack, NH (US); Maria Antoinette Meijburg, Boston, MA (US)

(21) Appl. No.: 17/087,791

(22) Filed: Nov. 3, 2020

Related U.S. Application Data
(60) Provisional application No. 62/954,007, filed on Dec. 27, 2019.

(51) Int. Cl. B60W 30/09; B60Q 9/00; B60R 22/195; B60R 21/0134; B60R 25/30; B60Q 1/52; B60W 10/30

(52) U.S. Cl. CPC B60W 30/09; B60Q 9/008; B60R 22/195; B60W 2554/00; B60R 25/302; B60Q 1/52; B60W 10/30; B60R 21/0134

(57) ABSTRACT

A safety system for a vehicle includes an object tracker circuit configured to receive sensor data representing objects located in an environment in which the vehicle is operating. The vehicle is operated by a navigation system independent of the safety system. A probabilistic model of the environment is generated. Generating of the probabilistic model includes, for each object of the one or more objects, generating a state of the object based on recursive Bayesian filtering of the sensor data. The state includes a spatiotemporal location of the object relative to the vehicle at a particular time and a velocity of the object relative to the vehicle at the particular time. A probability of collision of the vehicle is determined with a particular object at the particular time based on the probabilistic model of the environment. A collision warning is generated indicating the particular object and the particular time.

### CROSS-REFERENCE TO RELATED APPLICATION

This application claims the benefit of U.S. Provisional Application 62/954,007, filed on Dec. 27, 2019, which is incorporated herein by reference in its entirety.

### FIELD OF THE INVENTION

This description relates generally to operation of vehicles and specifically to a safety system for a vehicle.

### BACKGROUND

Operation of a vehicle from an initial location to a final destination often requires a user or a vehicle decision-making system to select a route through a road network from the initial location to a final destination. The route may involve meeting objectives such as not exceeding a maximum driving time. A complex route can require many decisions, making traditional algorithms for autonomous driving impractical. Traditional greedy algorithms are sometimes used to select a route across a directed graph from the initial location to a final destination. However, if a large number of other vehicles on the road use such a greedy algorithm, the selected route may become overloaded and increase the risk of collision.

### SUMMARY

A safety system for a vehicle includes an object tracker circuit configured to receive sensor data representing one or more objects located in an environment in which the vehicle is operating. The vehicle is guided by a navigation system of the vehicle independent of the safety system. A probabilistic model of the environment is generated that includes, for each object of the one or more objects, a state of the object based on recursive Bayesian filtering of the sensor data. The state includes a spatiotemporal location of the object relative to the vehicle at a particular time and a velocity of the object relative to the vehicle at the particular time. A probability of collision of the vehicle is determined with a particular object of the one or more objects at the particular time based on the probabilistic model of the environment. If the probability of collision is greater than zero, a collision warning is generated indicating the particular object and the particular time at which the vehicle and the object will collide. In response to the collision warning, an arbiter circuit transmits an emergency braking command to a control circuit of the navigation system. In response to receiving the emergency braking command, the control circuit performs an emergency braking operation to avoid a collision of the vehicle with the particular object.

In another aspect, a system includes one or more sensors configured to receive RADAR data and camera images representing one or more objects located within an environment in which a vehicle is operating. An object tracker circuit is communicably coupled to the one or more sensors and configured to receive a trajectory of the vehicle from a navigation system of the vehicle. The navigation system is independent of the object tracker circuit. A representation of the environment is generated by performing data fusion on the RADAR data and the camera images. The representation includes, for each object of the one or more objects, a state of the object, an error covariance of the state, and an existence probability of the state. An operation is performed on the representation and the trajectory to identify a particular object of the one or more objects. If a time-to-collision (TTC) of the vehicle with the particular object is less than a threshold time, an arbiter circuit generates an emergency braking command. The emergency braking command indicates the TTC of the vehicle with the particular object. A control circuit is communicably coupled to the arbiter circuit and configured to operate the vehicle in accordance with the emergency braking command, such that the emergency braking avoids a collision of the vehicle with the particular object.

In another aspect, a system includes an object tracker circuit configured to receive sensor data from one or more RADAR sensors and one or more cameras of a vehicle. The sensor data represents one or more objects. Responsive to the determining that a first probability of collision of the vehicle with a particular object is greater than zero, a first collision warning is generated. A dynamic occupancy grid circuit is configured to determine a second probability of collision of the vehicle with the particular object based on a dynamic occupancy grid including multiple time-varying particle density functions. Each time-varying particle density function is associated with a location of an object of the one or more objects. A second collision warning is generated, responsive to the second probability of collision being greater than zero. An arbiter circuit is communicably coupled to the object tracker circuit and the dynamic occupancy grid circuit. The arbiter circuit is configured to validate the first collision warning against the second collision warning. A throttle-off command is transmitted to a control circuit of the vehicle. The control circuit is configured to operate the vehicle in accordance with the throttle-off command to avoid a collision of the vehicle with the particular object.

These and other aspects, features, and implementations can be expressed as methods, apparatus, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 is a block diagram illustrating an example of an autonomous vehicle (AV) having autonomous capability, in accordance with one or more embodiments.

FIG. 2 is a block diagram illustrating an example “cloud” computing environment, in accordance with one or more embodiments.

FIG. 3 is a block diagram illustrating a computer system, in accordance with one or more embodiments.

FIG. 4 is a block diagram illustrating an example architecture for an AV, in accordance with one or more embodiments.

FIG. 5 is a block diagram illustrating an example of inputs and outputs that may be used by a perception module, in accordance with one or more embodiments.

FIG. 6 is a block diagram illustrating an example of a LiDAR system, in accordance with one or more embodiments.

FIG. 7 is a diagram illustrating the LiDAR system in operation, in accordance with one or more embodiments.

FIG. 8 is a block diagram illustrating the operation of the LiDAR system in additional detail, in accordance with one or more embodiments.

FIG. 9 is a block diagram illustrating the relationships between inputs and outputs of a planning module, in accordance with one or more embodiments.

FIG. 10 illustrates a directed graph used in path planning, in accordance with one or more embodiments.

FIG. 11 is a block diagram illustrating the inputs and outputs of a control module, in accordance with one or more embodiments.

FIG. 12 is a block diagram illustrating the inputs, outputs, and components of a controller, in accordance with one or more embodiments.

FIG. 13 is a block diagram illustrating a safety system of a vehicle, in accordance with one or more embodiments.

FIG. 14 is a flow diagram of a process for operation of a safety system of a vehicle, in accordance with one or more embodiments.

FIG. 15 is a flow diagram of a process for operation of a safety system of a vehicle, in accordance with one or more embodiments.

FIG. 16 is a flow diagram of a process for operation of a safety system of a vehicle, in accordance with one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. System Overview
3. Autonomous Vehicle Architecture
4. Autonomous Vehicle Inputs
5. Autonomous Vehicle Planning
6. Autonomous Vehicle Control
7. Architecture for a Safety System
8. Processes for Operation of a Safety System

### System Overview

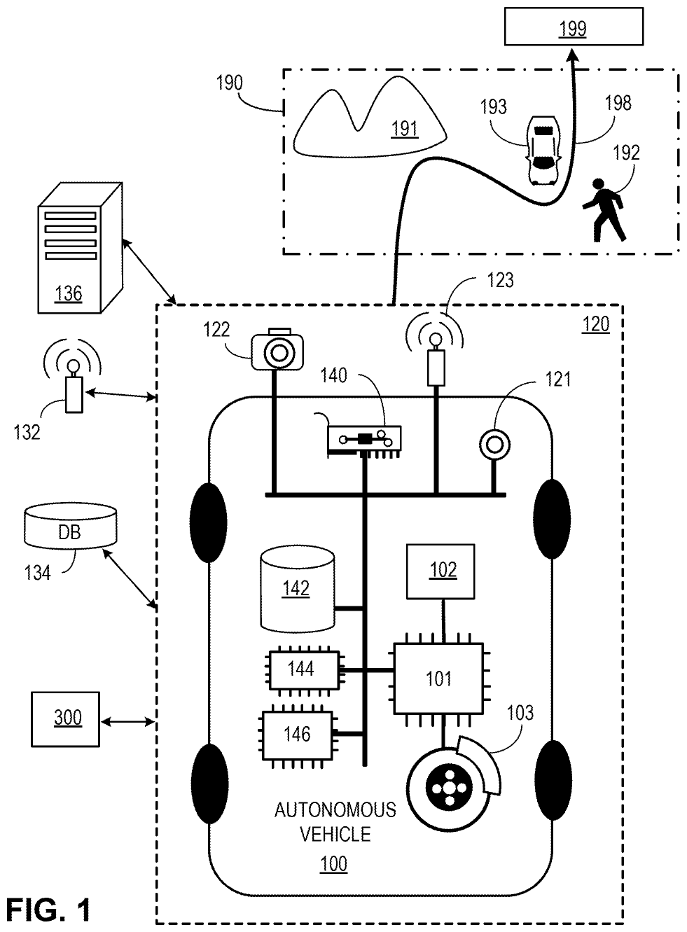

FIG. 1 is a block diagram illustrating an example of an autonomous vehicle 100 having autonomous capability, in accordance with one or more embodiments.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to operate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle and may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings or having two lanes between the lane markings. A lane could also be interpreted in the absence of lane markings. For example, a lane may be defined based on physical features of an environment, e.g., rocks and trees along a thoroughfare in a rural area.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “includes,” and/or “including,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

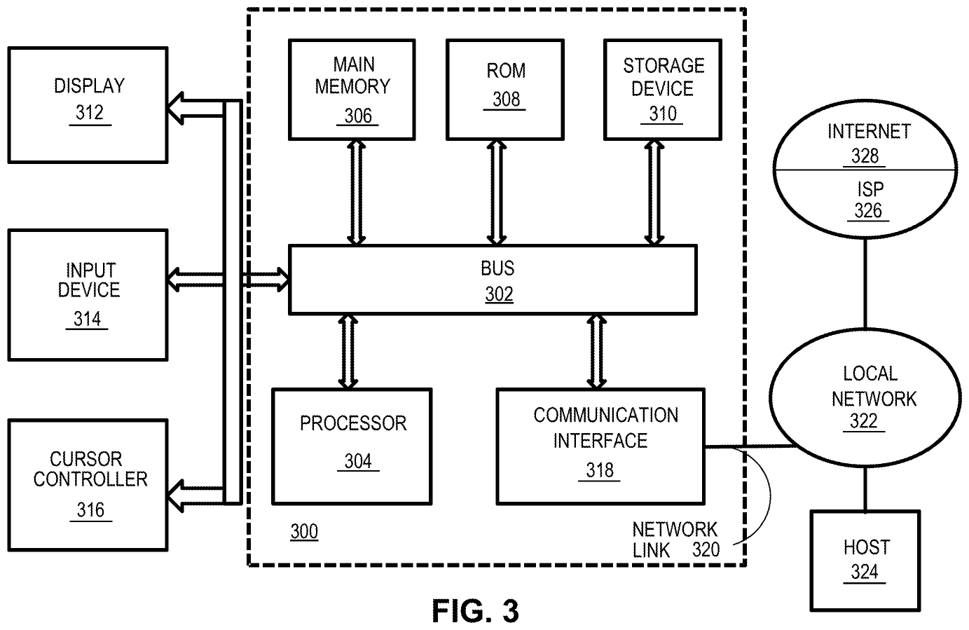

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear velocity and acceleration, angular velocity and acceleration, and heading (e.g., an orientation of the leading end of AV 100). Example of sensors 121 are GNSS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

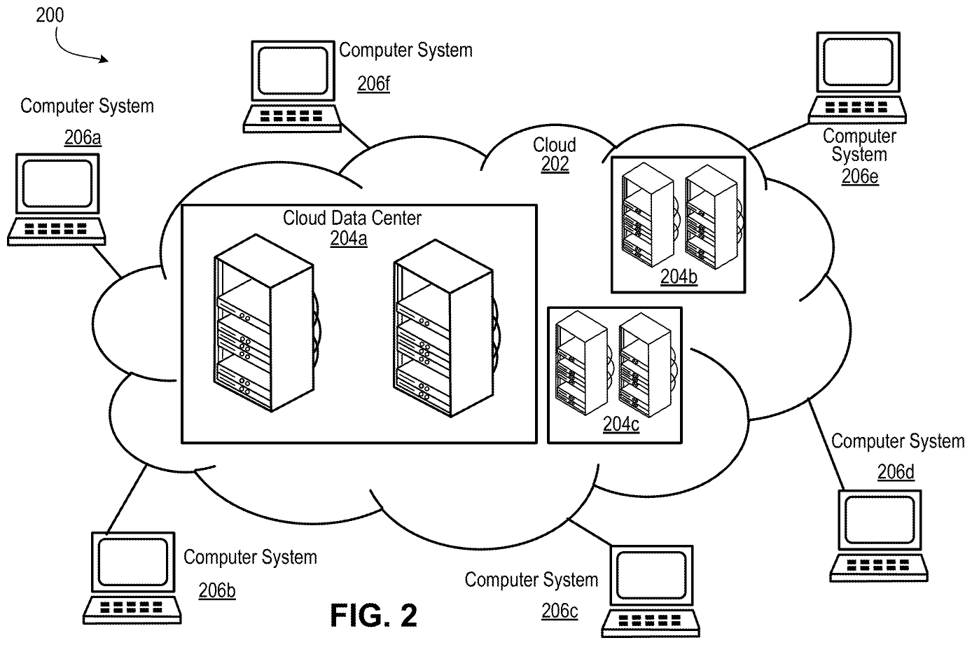

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

### Example Cloud Computing Environment

FIG. 2 is a block diagram illustrating an example “cloud” computing environment, in accordance with one or more embodiments. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

### Computer System

FIG. 3 is a block diagram illustrating a computer system 300, in accordance with one or more embodiments. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that include the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic, or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Autonomous Vehicle Architecture

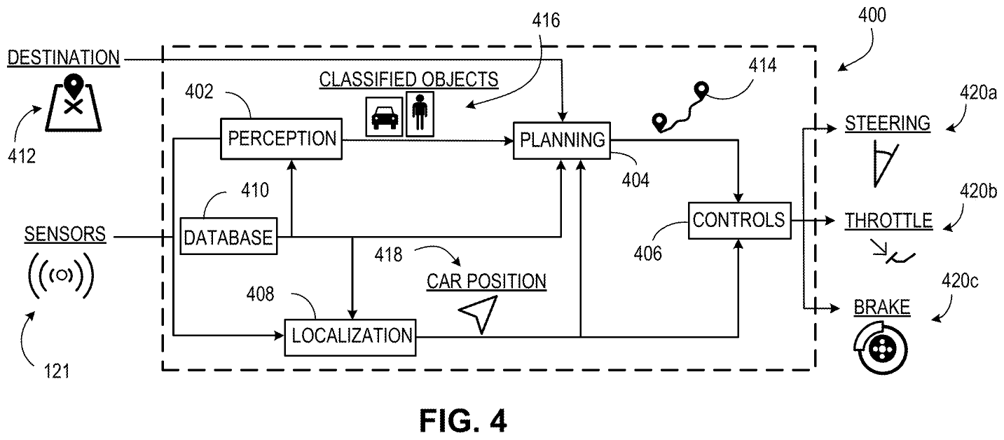

FIG. 4 is a block diagram illustrating an example architecture 400 for an autonomous vehicle (e.g., the AV 100 shown in FIG. 1), in accordance with one or more embodiments. The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things).

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS (Global Operation Satellite System) sensor and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Autonomous Vehicle Inputs

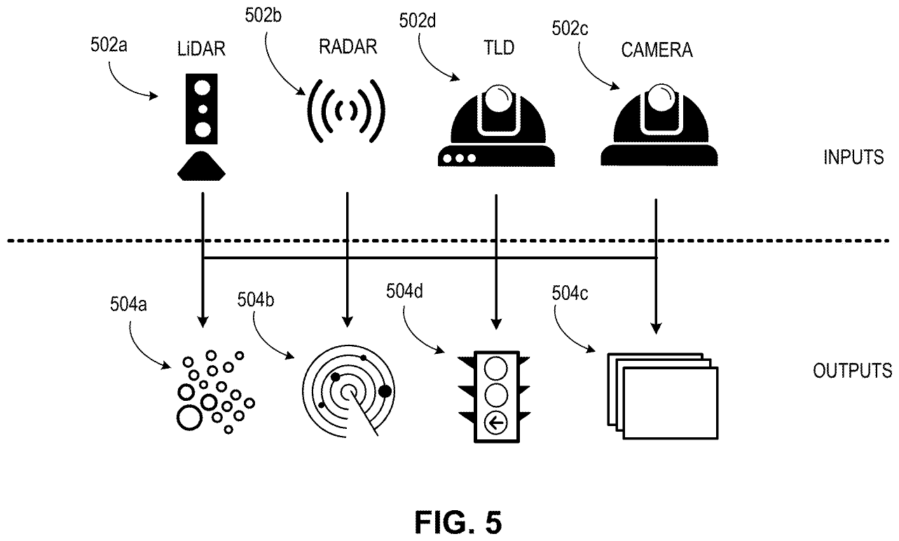

FIG. 5 is a block diagram illustrating an example of inputs 502a-d (e.g., sensors 121 shown in FIG. 1) and outputs 504a-d (e.g., sensor data) that is used by the perception module 402 (FIG. 4), in accordance with one or more embodiments. One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system 502b produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system may be configured to “see” objects far, e.g., up to a kilometer or more ahead of the AV. Accordingly, the camera system may have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual operation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual operation information as possible, so that the AV 100 has access to all relevant operation information provided by these objects. For example, the viewing angle of the TLD system may be about 120 degrees or more.

In some embodiments, outputs 504a-d are combined using a sensor fusion technique. Thus, either the individual outputs 504a-d are provided to other systems of the AV 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

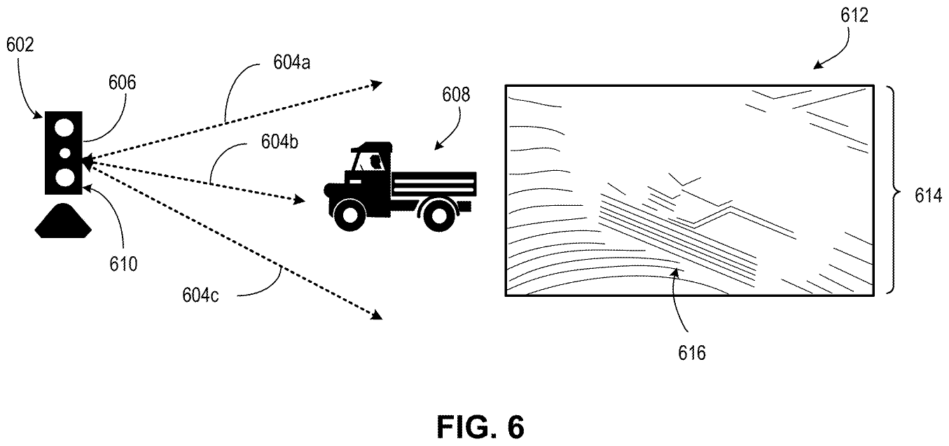

FIG. 6 is a block diagram illustrating an example of a LiDAR system 602 (e.g., the input 502a shown in FIG. 5), in accordance with one or more embodiments. The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

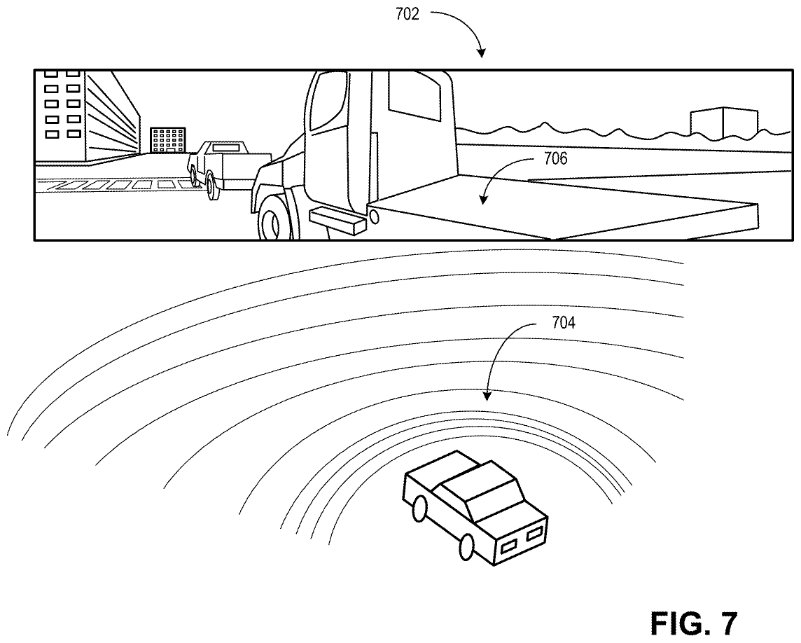

FIG. 7 is a block diagram illustrating the LiDAR system 602 in operation, in accordance with one or more embodiments. In the scenario shown in this figure, the AV 100 receives both camera system output 504c in the form of an image 702 and LiDAR system output 504a in the form of LiDAR data points 704. In use, the data processing systems of the AV 100 compares the image 702 to the data points 704. In particular, a physical object 706 identified in the image 702 is also identified among the data points 704. In this way, the AV 100 perceives the boundaries of the physical object based on the contour and density of the data points 704.

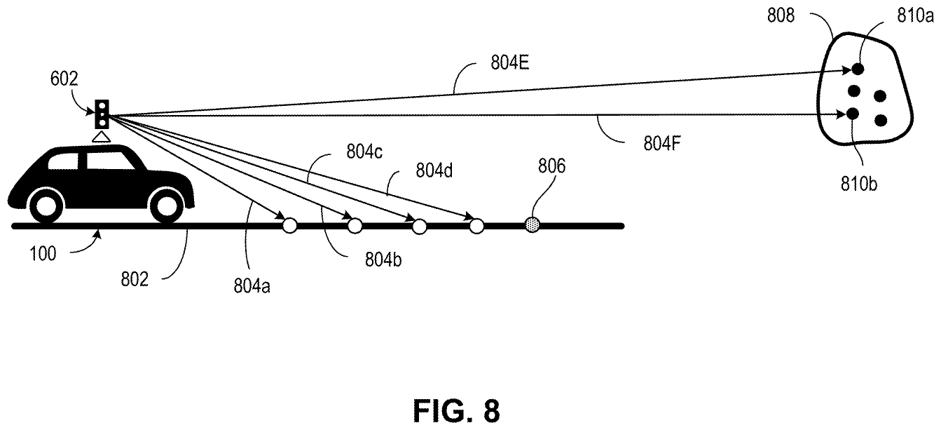

FIG. 8 is a block diagram illustrating the operation of the LiDAR system 602 in additional detail, in accordance with one or more embodiments. As described above, the AV 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

### Path Planning

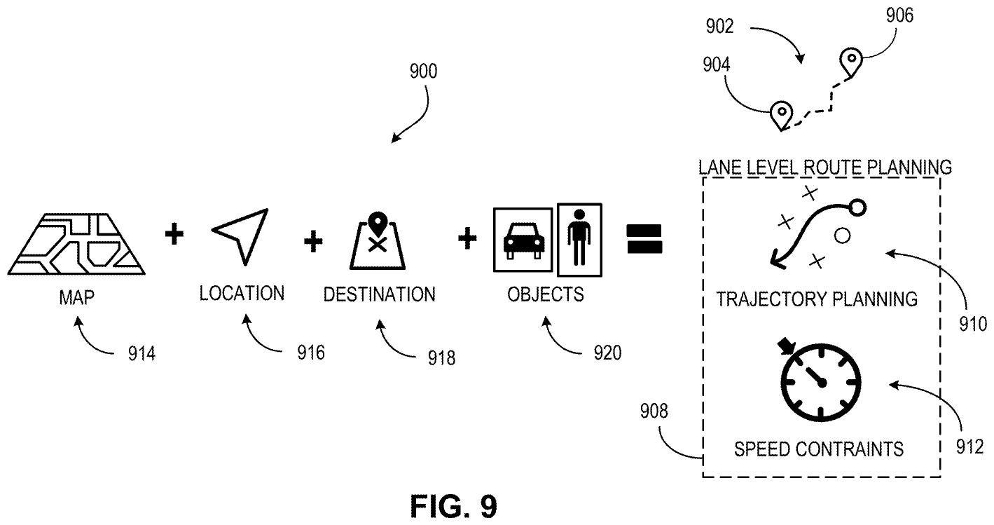

FIG. 9 is a block diagram 900 illustrating the relationships between inputs and outputs of a planning module 404 (e.g., as shown in FIG. 4), in accordance with one or more embodiments. In general, the output of a planning module 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the AV 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 may limit the AV 100 to a travel speed slower than an expected speed, e.g., a speed based on speed limit data for the segment.

In an embodiment, the inputs to the planning module 404 includes database data 914 (e.g., from the database module 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception module 402 as shown in FIG. 4). In some embodiments, the database data 914 includes rules used in planning. Rules are specified using a formal language, e.g., using Boolean logic. In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says, “if the road is a freeway, move to the leftmost lane” can have a lower priority than “if the exit is approaching within a mile, move to the rightmost lane.”

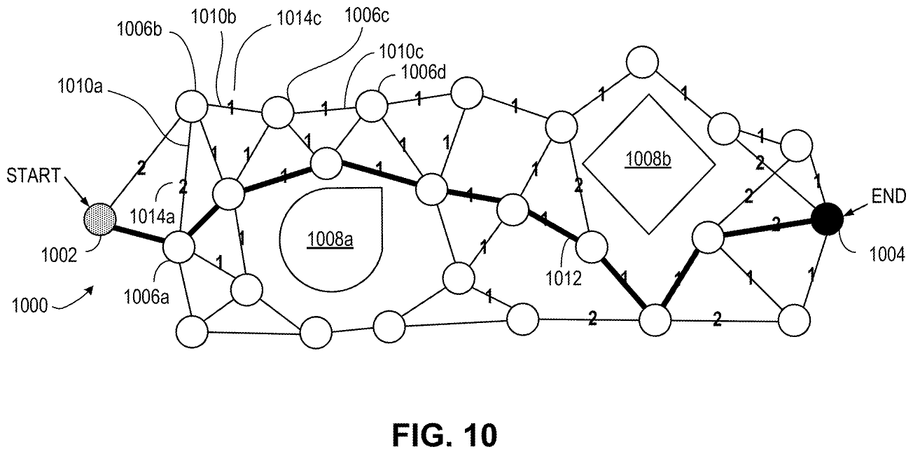

FIG. 10 illustrates a directed graph 1000 used in path planning, e.g., by the planning module 404 (FIG. 4), in accordance with one or more embodiments. In general, a directed graph 1000 like the one shown in FIG. 10 is used to determine a path between any start point 1002 and end point 1004. In real-world terms, the distance separating the start point 1002 and end point 1004 may be relatively large (e.g., in two different metropolitan areas) or may be relatively small (e.g., two intersections abutting a city block or two lanes of a multi-lane road).

In an embodiment, the directed graph 1000 has nodes 1006a-d representing different locations between the start point 1002 and the end point 1004 that could be occupied by an AV 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In an embodiment, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the AV 100.

The nodes 1006a-d are distinct from objects 1008a-b which cannot overlap with a node. In an embodiment, when granularity is low, the objects 1008a-b represent regions that cannot be traversed by automobile, e.g., areas that have no streets or roads. When granularity is high, the objects 1008a-b represent physical objects in the field of view of the AV 100, e.g., other automobiles, pedestrians, or other entities with which the AV 100 cannot share physical space. In an embodiment, one or more of the objects 1008a-b are static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for an AV 100 to travel between one node 1006a and the other node 1006b, e.g., without having to travel to an intermediate node before arriving at the other node 1006b. (When we refer to an AV 100 traveling between nodes, we mean that the AV 100 travels between the two physical positions represented by the respective nodes.) The edges 1010a-c are often bidirectional, in the sense that an AV 100 travels from a first node to a second node, or from the second node to the first node. In an embodiment, edges 1010a-c are unidirectional, in the sense that an AV 100 can travel from a first node to a second node, however the AV 100 cannot travel from the second node to the first node. Edges 1010a-c are unidirectional when they represent, for example, one-way streets, individual lanes of a street, road, or highway, or other features that can only be traversed in one direction due to legal or physical constraints.

In an embodiment, the planning module 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

### Autonomous Vehicle Control

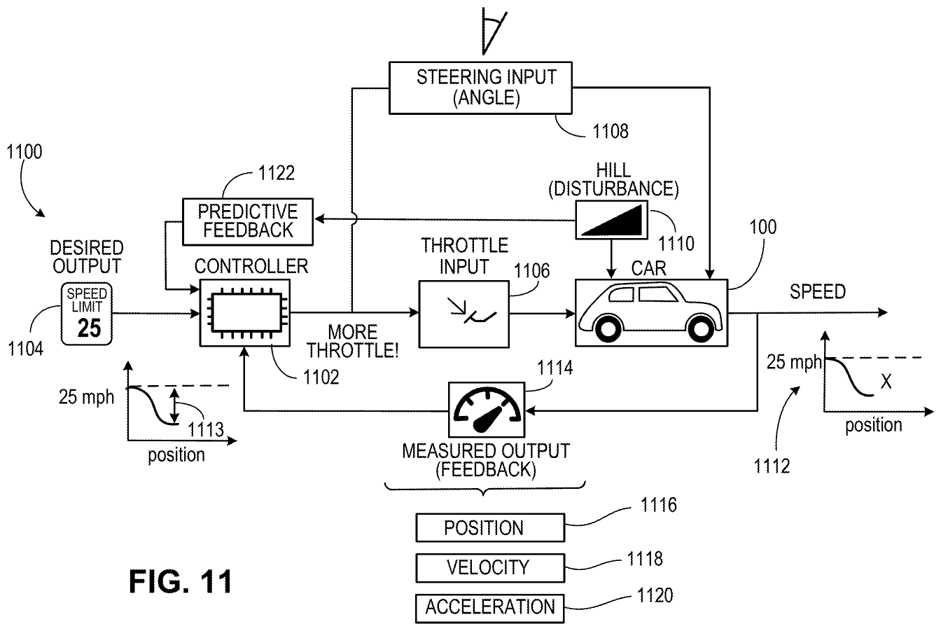

FIG. 11 is a block diagram 1100 illustrating the inputs and outputs of a control module 406 (e.g., as shown in FIG. 4), in accordance with one or more embodiments. A control module operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 308, and storage device 210, and instructions stored in memory that carry out operations of the controller 1102 when the instructions are executed (e.g., by the one or more processors).

In an embodiment, the controller 1102 receives data representing a desired output 1104. The desired output 1104 typically includes a velocity, e.g., a speed and a heading. The desired output 1104 can be based on, for example, data received from a planning module 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of an AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In an embodiment, the controller 1102 receives feedback that is used in adjusting the inputs provided to the throttle and steering. For example, if the AV 100 encounters a disturbance 1110, such as a hill, the measured speed 1112 of the AV 100 is lowered below the desired output speed. In an embodiment, any measured output 1114 is provided to the controller 1102 so that the necessary adjustments are performed, e.g., based on the differential 1113 between the measured speed and desired output. The measured output 1114 includes measured position 1116, measured velocity 1118, (including speed and heading), measured acceleration 1120, and other outputs measurable by sensors of the AV 100.

In an embodiment, information about the disturbance 1110 is detected in advance, e.g., by a sensor such as a camera or LiDAR sensor, and provided to a predictive feedback module 1122. The predictive feedback module 1122 then provides information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

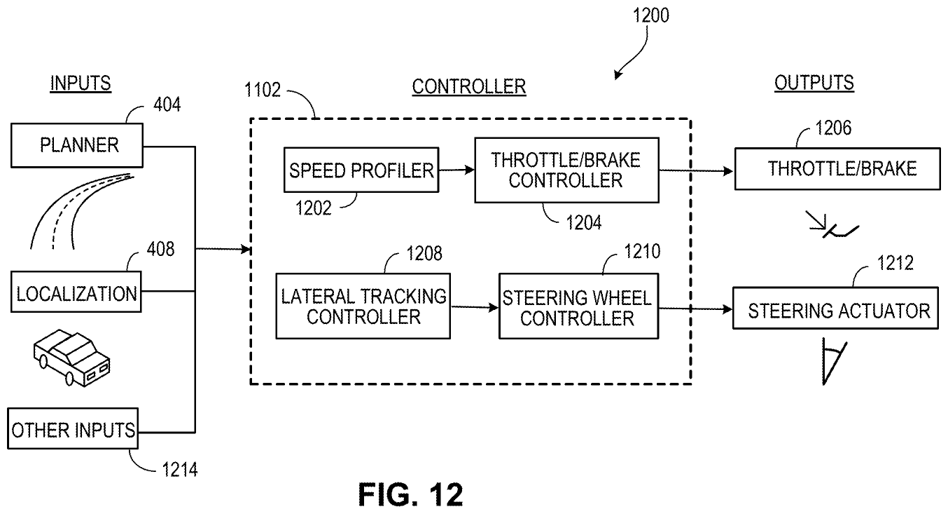

FIG. 12 is a block diagram 1200 illustrating the inputs, outputs, and components of the controller 1102, in accordance with one or more embodiments. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1204 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning module 404 provides information used by the controller 1102, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. In an embodiment, the controller 1102 receives information from other inputs 1214, e.g., information received from databases, computer networks, etc.

### Architecture for a Safety System

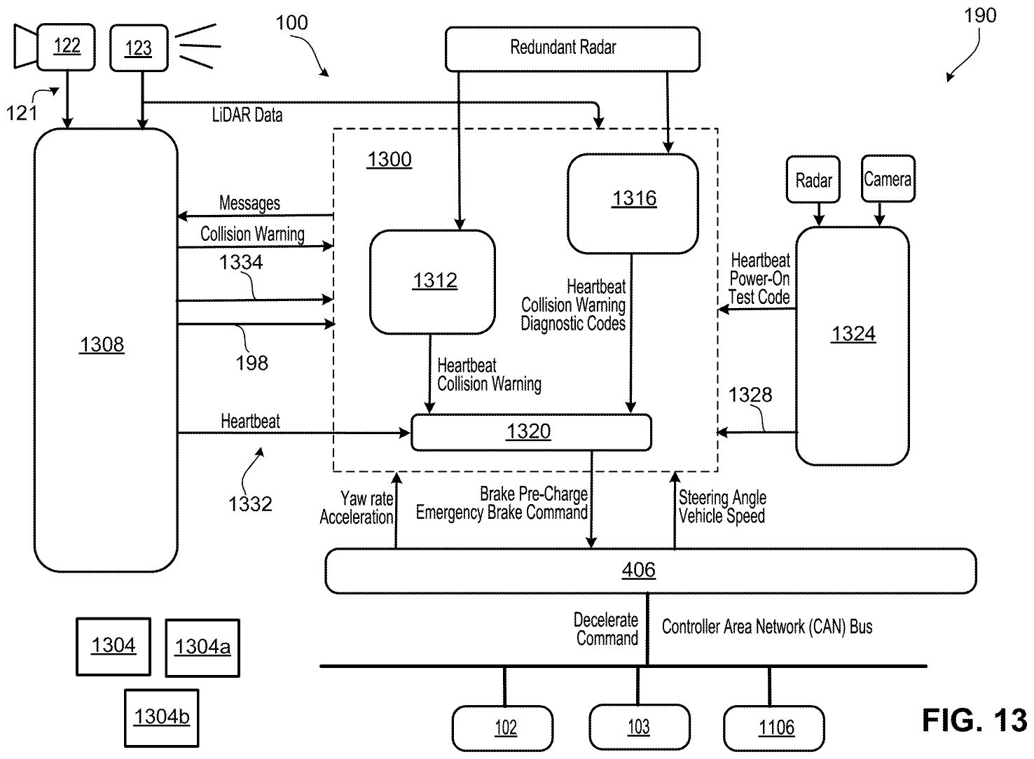

FIG. 13 is a block diagram illustrating an environment 190 for a vehicle, for example, the AV 100, illustrated and described in more detail with reference to FIG. 1, in accordance with one or more embodiments. The environment 190 includes the AV 100 and one or more objects 1304 including a particular object 1304a, for example, a vehicle or a pedestrian. The one or more objects 1304 are examples of the natural obstructions 191, vehicles 193, or pedestrians 192, illustrated and described in more detail with reference to FIG. 1. The AV 100 includes a navigation system 1308 and a safety system 1300. The navigation system 1308 is built using the components illustrated and described in more detail with reference to FIG. 3. The navigation system 1308 and the safety system 1300 are each independent parts of the AV system 120, illustrated and described in more detail with reference to FIG. 1.

The navigation system 1308 is used for normal (non-emergency) operation of the AV 100. In some embodiments, the navigation system 1308 is referred to as an AV stack. In other embodiments, the term AV stack refers to a combination of a mapping module (or the localization module 408), the perception module 402, the planning module 404, and the control circuit 406. In some embodiments, the navigation system 1308 includes the perception module 402, the planning module 404, and the control circuit 406, illustrated and described in more detail with reference to FIG. 1. In other embodiments, the control circuit 406 is located outside the navigation system 1308. The safety system 1300, on the other hand, is used for emergency operations, such as for automatic emergency braking to avoid a collision with the one or more objects 1304. The safety system 1300 is independent of but communicably coupled to the navigation system 1308, such that the safety system 1300 can receive a trajectory 198 from the navigation system 1308 or transmit braking and other commands to the control circuit 406. The trajectory 198 is illustrated and described in more detail with reference to FIG. 1.

The safety system 1300 includes an object tracker circuit 1312, a dynamic occupancy grid circuit 1316, and an arbiter circuit 1320. In some embodiments, the safety system 1300 includes one or more sensors 1324. The sensors 1324 can be located outside the safety system 1300 and communicate with the safety system 1300. The sensors 1324 are independent of the sensors 120, 121, 122, and 123 described in more detail with reference to FIG. 1. The sensors 1324 include at least one of a RADAR or a camera. The sensors 1324 can include monocular or stereo video cameras. The sensors 1324 sense or measure properties of the environment 190. In other embodiments, the safety system 1300 does not include the sensors 1324 and uses data from the sensors 121 and the monocular or stereo video cameras 122, which are routed to the navigation system 1308. In other embodiments, the sensors 121 and the monocular or stereo video cameras 122 are directly routed to the safety system 1300 for use by the object tracker circuit 1312.

In an embodiment, the sensors 1324 are smart sensors that perform motion compensation relative to motion of the AV 100 based on odometry data 1334. For example, the sensors 1324 can include wheel speed sensors and other odometry sensors that provide data for the safety system 1300 to detect a lane position of the AV 100. The safety system 1300 can use the AV 100 speed, pitch, roll, and yaw to determine the position of the AV 100 relative to a trajectory 198 computed by the navigation system 1308. The sensors 1324 receive or generate sensor data 1328 (for example, RADAR signals or camera images) representing the properties of the environment 190. In an embodiment, the sensors 1324 receive RADAR data and camera images representing the one or more objects 1304 located within the environment 190 in which the AV 100 is operating.

The safety system 1300 is sometimes referred to as an “automatic emergency braking (AEB) RADAR and camera (R&C) system.” In an embodiment, the R&C system hardware is packaged and attached to the aft side of the front windshield of the AV 100, fully within the dual windshield wiper zone. The R&C circuit operating the sensors 1324 is designed to be a redundant safety system having AEB capabilities. In an embodiment, the R&C system includes forward-looking sensors 1324 separate and distinct from the AV stack sensors 121. In an embodiment, the sensors 1324 are a RADAR and a camera from the Aptiv CADm-Lo® hardware product family. The RADAR data includes at least one of an azimuth angle of each object 1304, a range of the object 1304, a range rate of the object 1304, a return intensity of the RADARs, or a location of the RADARs.

In some embodiments in which the safety system 1300 includes the sensors 1324, the object tracker circuit 1312 receives the sensor data 1328 representing the one or more objects 1304 located in the environment 190 in which the AV 100 is operating. In other embodiments in which the safety system 1300 does not include the sensors 1324, the safety system 1300 receives data from the sensors 121 and the monocular or stereo video cameras 122. The object tracker circuit 1312 is built using the components illustrated and described in more detail with reference to FIG. 3. The object tracker circuit 1312 generates a probabilistic model of the environment 190 based on the sensor data 1328. To generate the probabilistic model, the object tracker circuit 1312 generates a probabilistic state of each object 1304. In some embodiments, recursive Bayesian filtering of the sensor data 1328 is used to generate the probabilistic state of the object 1304. In other embodiments, other probabilistic approaches are used to populate a dynamic occupancy grid using the dynamic occupancy grid circuit 1316. The object tracker circuit 1312 determines the probabilities of multiple “beliefs” (locations of each object 1304 and the AV 100) to allow the AV 100 to infer its position and orientation based on the sensor data 1328. In an embodiment, the sensor data 1328 is linearly distributed and the object tracker circuit 1312 performs the recursive Bayesian filtering using a Kalman filter. The Kalman filter uses the sensor data 1328 observed over time to produce estimates of the probabilistic state of each object 1304, such that the estimates are more accurate than those based on a single measurement alone.

For each object 1304, the probabilistic state includes a spatiotemporal location of the object 1304 denoted by [X, Y] in a coordinate system relative to the AV 100. The probabilistic state is determined at different times, such as at a particular time T. The probabilistic state includes a velocity [V_{X}, V_{Y}] of the object 1304 relative to the AV 100 at the particular time T. In an embodiment, the object tracker circuit 1312 is configured to determine the spatiotemporal location [X, Y] and the velocity [V_{X}, V_{Y}] of the object 1304 using Cartesian coordinates. In an embodiment, the probabilistic model of the environment 190 includes a Cartesian acceleration [A_{X}, A_{Y}] of the object 1304 relative to the AV 100. For each object 1304, a state space representation (probabilistic state) is created. The state space representation of an object 1304 at the time T is denoted by [X, Y, V_{X}, V_{Y}, A_{X}, A_{Y}]^{T}.

In an embodiment, the object tracker circuit 1312 is configured to receive odometry data 1334 from the one or more sensors 1324 or the sensors 121, illustrated and described in more detail with reference to FIG. 1. The object tracker circuit 1312 performs motion compensation on the probabilistic state of each object 1304 based on the odometry data 1334. The motion compensation is performed to track the probabilistic state of the object 1304 relative to motion of the AV 100. The object tracker circuit 1312 mathematically models the motion of the objects 1304 in the dynamic environment 190. The object tracker circuit 1312 performs object tracking using noisy measurements (the sensor data 1328) from the multiple sensors 1324 (such as RADARs or cameras) to derive both a number and characteristics of the objects 1304 by filtering the sensor data 1328 over time. Based on the probabilistic state of each object 1304, the object tracker circuit 1312 determines a distance from the object 1304 to the AV 100. For example, the distance is a lateral distance or a frontal distance from the AV 100. In an embodiment, the probabilistic model of the environment 190 is expressed in terms of a Cartesian coordinate system originating at the front bumper of the AV 100.

In an embodiment, the object tracker circuit 1312 generates the probabilistic model of the environment 190 using object-based modeling in which the probabilistic state of the particular object 1304a is independent of the probabilistic state of another object 1304b. The object tracker circuit 1312 is configured to generate the probabilistic state of the objects 1304 by estimating a binary existence probability of each object 1304 using a binary Bayes filter. For each object hypothesis (probabilistic state or “track”), an existence probability p(x) is estimated by the binary Bayes filter. The existence probability p(x) can be binary depending on whether a measurement from the sensor data 1328 can be associated to the track or not. In an embodiment, the object tracker circuit 1312 is configured to generate the probabilistic state of each object 1304 by estimating a Mahalanobis distance between a previous probabilistic state of the object 1304 and the sensor data 1328. The existence probability is determined to be continuous, considering the Mahalanobis distance between the track and the measurement.

In an embodiment, the object tracker circuit 1312 generates a representation (probabilistic model) of the environment 190 by performing data fusion on the RADAR data and the camera images (sensor data 1328). The probabilistic model of the environment 190 includes, for each object 1304, the probabilistic state of the object 1304, an error covariance P of the probabilistic state, and an existence probability p(x) of the state. The error covariance P refers to the joint variability of (a) the measurements of the object 1304 from the sensor data 1328 and (b) the probabilistic state of the object 1304. The existence probability p(x) refers to a function whose value at any given sample in the sample space is a likelihood that the probabilistic state of the object 1304 equals that sample. The existence probability p(x) is sometimes referred to as a probability density function (PDF). At each time step, the data fusion generates a synchronized matrix of objects 1304 denoted by the tracking time and object definition. Each object definition includes a track (probabilistic state of an object 1304), the error covariance P of the track, and the track's existence probability p(x).

In an embodiment, the object tracker circuit 1312 performs an operation (such as a matrix operation) on the representation (probabilistic model) of the environment 190 and the trajectory 198 to identify a particular object 1304a of the one or more objects 1304, such that a time-to-collision (TTC) of the AV 100 with the particular object 1304a is less than a threshold time. For example, the threshold time can be two or three seconds. In an embodiment, the TTC determinations are performed with respect to the front bumper of the AV 100. In an embodiment, if the TTC is below a collision warning threshold time, the safety system 1300 transmits a brake pre-charge and deceleration request (emergency braking command) to the control circuit 406. The safety system 1300 thus combines the trajectory 198 and the object track matrix (probabilistic model) of the environment 190 to sense the particular object 1304a. The safety system 1300 uses the coordinate framework of the AV 100 for the computation.

In an embodiment, the object tracker circuit 1312 determines a first probability of collision of the AV 100 with a particular object 1304a of the one or more objects 1304 at the particular time T based on the probabilistic model of the environment 190. When the first probability of collision is greater than zero, the object tracker circuit 1312 generates a first collision warning indicating the particular object 1304a and the particular time T. In an embodiment, the object tracker circuit 1312 is further configured to receive a trajectory 198 of the AV 100 from the navigation system 1308 via a connectivity circuit 1332. The safety system 1300 is independent of but communicates with the navigation system 1308 (and its control software development kits (SDKs)) via the connectivity circuit 1332 that carries the data traffic, and also compresses and decompresses or encrypts messages between the safety system 1300 and the navigation system 1308. The object tracker circuit 1312 determines the first probability of collision based on the trajectory 198. For example, the probabilistic model of the environment 190 is used to determine whether the particular object 1304a intersects with the trajectory 198 to predict a collision with the AV 100.

The object tracker circuit 1312 is further configured to identify a travel lane in the environment 190 within which the AV 100 is operating based on the RADAR and camera images. Camera images of lane markings are used to determine a position of the AV 100 relative to the lane markings. The object tracker circuit 1312 determines that the particular object 1304a has a “low” TTC (for example, less than five seconds) based on the travel lane. The AV 100 may be laterally close to an object 1304. However, if the object 1304 and the AV 100 are each operating in separate travel lanes, the object tracker circuit 1312 will determine that the first probability of collision is zero. Further, the object 1304 may be a vehicle approaching the AV 100 in a direction opposite to the direction in which the AV 100 is operating. However, the object tracker circuit 1312 determines that there is a lane divider separating the AV 100 and the object 1304. The safety system 1300 will not be activated to perform emergency braking. In an embodiment, the object tracker circuit 1312 determines a spatiotemporal location of the AV 100 based on a speed of the AV 100, a pitch of the AV 100, a roll of the AV 100, and a yaw of the AV 100. The first probability of collision is determined based on the spatiotemporal location of the AV 100.

The object tracker circuit 1312 is further configured to receive control data from the control circuit 406. The control data can include a speed of the AV 100, a steering angle of the AV 100, an acceleration, a yaw rate, etc. The control data is received by the object tracker circuit 1312 prior to the control circuit 406 operating the AV 100 in accordance with the control data. The control data is received by the object tracker circuit 1312 at a particular frequency. For example, the control data transmitted from the control circuit 406 to the safety system 1300 includes a three-second “look-ahead” of speed and steering profile, and is updated at a frequency of 10 Hz. The control data can be matched to the trajectory 198 or used to verify a location of the AV 100 relative to the particular object 1304a.

The one or more sensors 1324 are further configured to perform a power-on self-test when the safety system 1300 is powered up. The power-on self-test is a diagnostic test sequence that the basic input/output system (BIOS) of the sensors 1324 executes to determine if the sensors 1324 and their controlling hardware are working correctly. Responsive to the one or more sensors 1324 failing the power-on self-test, the object tracker circuit 1312 transmits a diagnostic code representing the failing of the power-on self-test to the arbiter circuit 1320 to disable the safety system 1300. Thus, if the sensors 1324 fail the self-check, the AEB function will not be active.

The dynamic occupancy grid circuit 1316 performs collision prediction independently based on LiDAR data received from the LiDARs 123 of the AV 100, the trajectory 198, and the control data. The dynamic occupancy grid circuit 1316 is built using the components illustrated and described in more detail with reference to FIG. 3. The LiDARs 123 are illustrated and described in more detail with reference to FIG. 1. The dynamic occupancy grid circuit 1316 is communicably coupled to the arbiter circuit 1320 and configured to determine a second probability of collision of the AV 100 with the particular object 1304a based on a dynamic occupancy grid of the environment 190.

The dynamic occupancy grid refers to a discretized representation of the environment 190 of the AV 100. The dynamic occupancy grid includes a grid map with multiple individual cells (cubes) that each represents a unit area (or volume) of the environment 190. In some implementations, the dynamic occupancy grid circuit 1316 is configured to update an occupancy probability of each individual grid cell. Each occupancy probability represents a likelihood of presence of one or more of the classified objects 1304 in the individual cell. In an embodiment, the dynamic occupancy grid includes multiple time-varying particle density functions. Each time-varying particle density function is associated with a location of an object 1304. Responsive to the second probability of collision exceeding a threshold, the dynamic occupancy grid circuit 1316 generates a second collision warning indicating the particular object 1304a. The dynamic occupancy grid circuit 1316 generates the second collision warning, responsive to the second probability of collision being greater than zero.

The arbiter circuit 1320 is communicably coupled to the object tracker circuit 1312 to receive signals, such as a heartbeat signal and the first collision warning from the object tracker circuit 1312. The heartbeat signal indicates that the object tracker circuit 1312 is powered on and functioning as intended. The arbiter circuit 1320 is built using the components illustrated and described in more detail with reference to FIG. 3. For each track, the object tracker circuit 1312 computes a TTC. After the arbiter circuit 1320 is initialized, the arbiter circuit 1320 listens for and analyzes heartbeat signals and diagnostic codes from the object tracker circuit 1312 and the dynamic occupancy grid circuit 1316. The arbiter circuit 1312 collects diagnostics from the object tracker circuit 1312 and the dynamic occupancy grid circuit 1316, monitors a power-on status signal, and monitors an AV automatic/manual button status signal.

Responsive to receiving the first collision warning from the object tracker circuit 1312, the arbiter circuit 1320 transmits an emergency braking command to the control circuit 406 of the navigation system 1308. The safety system 1300 includes the object tracker circuit 1312 (for multi-object tracking) and the dynamic occupancy grid circuit 1316 as redundant collision warning systems that receive the raw sensor data 1328 and control data from the control circuit 406 independent of the navigation system 1308. The object tracker circuit 1312 and the dynamic occupancy grid circuit 1316 make independent decisions on whether to deaccelerate the AV 100. The arbiter circuit 1312 is further configured to monitor messages received from the dynamic occupancy grid circuit 1316. In an embodiment, the arbiter circuit 1312 is further configured to receive an additional collision warning from the navigation system 1308. The arbiter circuit 1312 validates the first collision warning and the second collision warning against the additional collision warning. For example, the arbiter circuit 1312 performs triple modular redundancy validation between the navigation system 1308, the object tracker circuit 1312, and the dynamic occupancy grid circuit 1316.

The arbiter circuit 1320 verifies the first collision warning from the object tracker circuit 1312 against the second probability of collision determined by the dynamic occupancy grid circuit 1316 of the safety system 1300 based on the sensor data 1328. The transmitting of an emergency braking command from the arbiter circuit 1320 to the control circuit 406 is performed, responsive to the verifying of the second probability of collision. In an embodiment, the arbiter circuit 1320 is further configured to validate a second collision warning generated by the dynamic occupancy grid circuit 1316 against a first collision warning generated by the object tracker circuit 1312. The second collision warning is generated based on the TTC of the AV 100 with the particular object 1304. In an embodiment, the arbiter circuit 1320 validates the first collision warning against the second collision warning by performing arbitration between the object tracker circuit 1312 and the dynamic occupancy grid circuit 1316.

Prior to the validating of the first collision warning against the second collision warning, the arbiter circuit 1320 is configured to determine that a first heartbeat signal has been received from the object tracker circuit 1312. The arbiter circuit 1320 is configured to determine that a second heartbeat signal has been received from the dynamic occupancy grid circuit 1316. The arbiter circuit 1320 is configured to determine that the AV 100 is powered on. The arbiter circuit 1320 monitors a power-on status signal and an AV automatic/manual button status signal.

The arbiter circuit 1320 generates an emergency braking command, responsive to the object tracker circuit 1312 identifying a “low” (for examples, less than two seconds) TTC of the AV 100 with the particular object 1304a. The arbiter circuit 1320 is further configured to transmit the emergency braking command to the navigation system 1308, such that the navigation system 1308 is enabled to generate a new trajectory for the AV 100. The new trajectory is required because the current trajectory 198 resulted in the emergency braking operation. In generating the new trajectory, the planning module 404 will attempt to steer away from the objects 1304, as illustrated and described in more detail with reference to FIG. 9.

In an embodiment, the object tracker circuit 1312 is further configured to determine a size of an object 1304 based on the RADAR data and the camera images. For example, sometimes debris is encountered on a road. The safety system 1300 relies on sensors 1324 that have a wide field-of-view for the purpose of tracking lateral objects at-speed. The object tracker circuit 1312 determines that the size of the object 1304 is smaller than a threshold size. For example, a threshold size of 20 cm×20 cm is used. Responsive to the determining that the size of the object 1304 is smaller than the threshold size, the object tracker circuit 1312 transmits a heartbeat signal to the arbiter circuit 1320 to enable the control circuit 406 to continue operating the AV 100 in accordance with the trajectory 198. The safety system 1300 does not transmit the first collision warning to the planning module 404 or a deceleration request (emergency braking command) to the control circuit 406.

The arbiter circuit 1320 is further configured to determine that the object tracker circuit 1312 has failed to transmit a heartbeat signal to the arbiter circuit 1320 for greater than a threshold time period. For example, a threshold time period of between 30 seconds and 3 minutes can be selected. Responsive to the determining that the object tracker circuit 1312 has failed to transmit the heartbeat signal, the arbiter circuit 1320 disables the safety system 1300. The navigation system 1308 now controls the AV 100. The navigation system 1308 may perform a comfort stop, such that diagnostics or repairs can be performed on the AV 100. A comfort stop refers to a smooth (non-emergency) braking operation in accordance with a comfort profile of the AV 100 or a passenger riding in the AV 100.

In an embodiment, responsive to determining that the object tracker circuit 1312 has failed to transmit the heartbeat signal to the arbiter circuit 1320, the arbiter circuit 1320 transmits a message to the navigation system 1308 to perform a braking operation in accordance with a passenger comfort profile of a passenger riding in the AV 100. For example, if the heartbeat signal is not received by the arbiter circuit 1320 and the speed of the AV 100 is greater than a threshold speed (for example, 0.5 mph), the arbiter circuit 1320 instructs the planning module 404 to perform a comfort stop.

The arbiter circuit 1320 is further configured to receive diagnostic codes from the object tracker circuit 1312 and dynamic occupancy grid circuit 1316. A diagnostic code can indicate a presence of a failure in the object tracker circuit 1312 or dynamic occupancy grid circuit 1316. Responsive to the receiving of the diagnostic code, the arbiter circuit 1320 ignores future messages from the object tracker circuit 1312 or dynamic occupancy grid circuit 1316. For example, the AV 100 is operating in autonomous mode. The arbiter circuit 1312 periodically monitors heartbeat signals and diagnostic codes from the object tracker circuit 1312 and the dynamic occupancy grid circuit 1316. The arbiter circuit 1312 detects a diagnostic code indicating a failure from the object tracker circuit 1312. The arbiter circuit 1312 ignores future messages from the object tracker circuit 1312.

The object tracker circuit 1312 is further configured to receive control data from the control circuit 406. The control data includes at least a steering wheel angle of the AV 100. The control data can further include at least one of a brake pressure or a steering wheel torque. The object tracker circuit 1312 compares the trajectory 198 received from the navigation system 1308 to the control data. The object tracker circuit 1312 may determine a mismatch between the control data and the trajectory 198 based on the comparing. A mismatch can occur when there is a mechanical misalignment in the steering system 102, the position of the AV 100 does not match the trajectory 198, or the trajectory data from the navigation system 1308 may be stuck due to latency (for example, latency of path data signal). Responsive to the determining of the mismatch, the object tracker circuit 1312 transmits a message to the navigation system 1308 to generate a new trajectory based on the mismatch. The information regarding the mismatch is thus transmitted to the planning module 404 to incorporate into the path planning.

In an embodiment, the arbiter circuit 1320 can perform functions typically performed by the navigation system 1308. Such functions can be performed, for example, when there is a mismatch between the control data and the trajectory 198. For example, the arbiter circuit 1320 determines that a speed of the AV 100 is greater than a threshold speed (such as 40 mph or 60 mph). Responsive to the determining that the speed of the AV 100 is greater than the threshold speed, the arbiter circuit 1320 transmits a deceleration command (emergency braking command) to the control circuit 406.

When the AV 100 is powered on, the safety system 1300 becomes active. The AV system 120 may be in manual mode. The arbiter circuit 1320 determines that a TTC with respect to the particular object 1304a is below a threshold time, for example two seconds. The arbiter circuit 1320 determines that the AV 100 is being operated by a user. This situation occurs when the safety system 1300 identifies a low TTC event in manual mode but the user does not brake or actively steer away from the particular object 1304a. Responsive to the low TTC event, the arbiter circuit 1320 determines an absence of a brake pressure applied by the user. The R&C AEB system activates. Responsive to the determining of the absence of the brake pressure, the arbiter circuit 1320 transmits an emergency braking command to the control circuit 406.

In an embodiment, the arbiter circuit 1320 is further configured to determine that the AV 100 is being operated by a user within the AV 100 (non-autonomous manual mode). Responsive to receiving the first collision warning, the arbiter circuit 1320 may determine that a brake pressure has in fact been applied by the user. Responsive to the determining that the brake pressure has been applied, the arbiter circuit 1320 transmits a message to the control circuit 406 to operate the AV 100 in accordance with control information received from the user. For example, once the AV 100 is powered on, the R&C AEB system 1300 becomes active. The AV system 120 is in manual mode and a user is piloting the AV 100. The safety system 1300 identifies a “low” TTC event. The user brakes (or actively steers) the AV 100. Upon determining the user engagement, the R&C AEB system 1300 does not activate.

In a particular emergency braking scenario, the arbiter circuit 1320 transmits a throttle-off command to the control circuit 406. The AV 100 is decelerated by the control circuit 406. Responsive to the transmitting of the throttle-off command, the arbiter circuit 1320 receives a third collision warning from the dynamic occupancy grid circuit 1316. Responsive to the receiving of the third collision warning, the arbiter circuit 1320 transmits a command to the control circuit 406 to increase the amount of deceleration of the AV 100. For example, the arbiter circuit 1320 receives the second collision warning from the dynamic occupancy grid circuit 1316. The arbiter circuit 1320 senses that the speed of the AV 100 is greater than 0.5 mph. The arbiter circuit 1320 transmits a request for a “medium” amount (for example, 6 m/s²) of deceleration (emergency braking command) to the control circuit 406. The dynamic occupancy grid circuit 1316 begins to transmit requests for a greater than “medium” amount of deceleration to the arbiter circuit 1312. The arbiter circuit 1312 transmits the requests for a greater than medium amount of deceleration to the control module 406.

The arbiter circuit 1320 is further configured to initiate recording at least one of the control data, the sensor data 1328, or other signals, by a black box of the AV 100, responsive to the transmitting of the throttle-off command by the arbiter circuit 1320 to the control module 406. For example, the safety system 1300 initiates the recording of black box data, triggered by an emergency braking event initiated by the safety system 1300. The emergency braking event is not in accordance with the regular trajectory 198. The black box data includes control data from a time period (for example, 1 second or 30 seconds) prior to the emergency braking event. The control data can include a speed of the AV 100, a steering angle of the AV 100, or a brake pedal status of the AV 100. The black box data includes time stamps for each data signal, such as a speed, a steering angle, internal signals, or output signals. The internal signals refer to the tracks, probability of collision, confidence level, TTC, etc. The output signals refer to the throttle-off command, brake pre-charge command, deceleration level, etc. The black box recording can further include RADAR tracks, camera tracks, fused tracks, a classification of the sensor data 1328, etc.

The control circuit 406 is illustrated and described in more detail with reference to FIG. 4. The control circuit 406 is built using the components illustrated and described in more detail with reference to FIG. 3. Responsive to receiving an emergency braking command from the arbiter circuit 1320, the control circuit 406 is configured to perform an emergency braking operation to avoid a collision of the AV 100 with the particular object 1304a. The safety system 1300 thus monitors and drives the control circuit 406 to react to the objects 1304 in proximity of the AV 100. In an embodiment, the control circuit 406 performs the emergency braking operation by turning off a throttle of the AV 100. For the example, the control circuit 406 sends a command to the throttle input 1106 illustrated and described in more detail with reference to FIG. 11. In an embodiment, the control circuit 406 performs the emergency braking operation by using an actuator to increase a tension in one or more seat belts of the AV 100 to increase safety for a passenger riding in the AV 100.

In an embodiment, the control circuit 406 performs the emergency braking operation by pre-charging brakes 103 of the AV 100. The brakes 103 are illustrated and described in more detail with reference to FIG. 1. The control circuit 406 performs the emergency braking operation by maintaining a brake pressure on the brakes 103 of the AV 100, such that the AV 100 comes to a stop. In an embodiment, the control circuit 406 performs the emergency braking operation by turning on emergency flashing lights of the AV 100 to signal the emergency braking operation.

In an embodiment, the control circuit 406 performs the emergency braking operation by recording vehicle data of the AV 100 by a black box of the AV 100. The vehicle data includes the speed of the AV 100, recent sensor data 1328, and the probabilistic state of the particular object 1304a. For example, after the AV 100 is powered on, the safety system 1300 becomes active. The AV system 120 is in automatic (autonomous) mode. The navigation system 1308 is piloting the AV 100. The safety system 1300 identifies a “low” TTC event, for example, having a TTC of less than two seconds. The safety system 1300 activates and takes over control of the AV 100 from the navigation system 1308. The safety system 1300 issues commands to the control circuit 406 in the following order: throttle-off, seat belt pretension (if available on the AV 100 platform), brake pre-charge, emergency braking command, begin internal black box data recording, emergency flashing lights command. The deceleration brings the AV 100 to a stop. The safety system 1300 instructs the control circuit 406 to maintain the pressure on the brakes 103 to keep the AV 100 stationary.

The control circuit 406 operates the AV 100 in accordance with an emergency braking command from the arbiter circuit 1320, such that the emergency deceleration avoids a collision of the AV 100 with the particular object 1304a. In the event of a collision, the post-collision analysis performed compares the safety system 1300 data (the black box recordings of the object tracker circuit 1312 data and the dynamic occupancy grid circuit 1316 data) with the navigation system 1308 data. In an embodiment, the object tracker circuit 1312 data, the dynamic occupancy grid circuit 1316 data, and the navigation system 1308 data are recorded with respect to the coordinate system originating at the rear axle center point of the AV 100.

In an embodiment, the navigation system 1308 operates the AV 100 in accordance with a comfort profile of the AV 100 or a passenger (level of passenger comfort measured by passenger sensors located on the AV 100) . The passenger sensors include specialized sensors to record data such as facial expressions of the passenger, skin conductance, pulse and heart-rate, a temperature of the passenger's body, pupil dilation, and pressure on the AV seat arm rests. Each type of data can be recorded using a different sensor or a combination of different sensors, for example, heart rate monitors, a sphygmomanometer, a pupilometer, an Infrared thermometer, or a galvanic skin response sensor. The planning module 404 plans the trajectory 198 based on, for example, an elevated heart rate or skin conductance level as detected by the passenger sensors indicative of passenger discomfort or stress. As would be understood by one of ordinary skill, one or more physical measurements of one or more passengers may be correlated with a level of discomfort or stress and that may be adjusted for by one or more motion constraints.

### Processes for Operation of Safety System

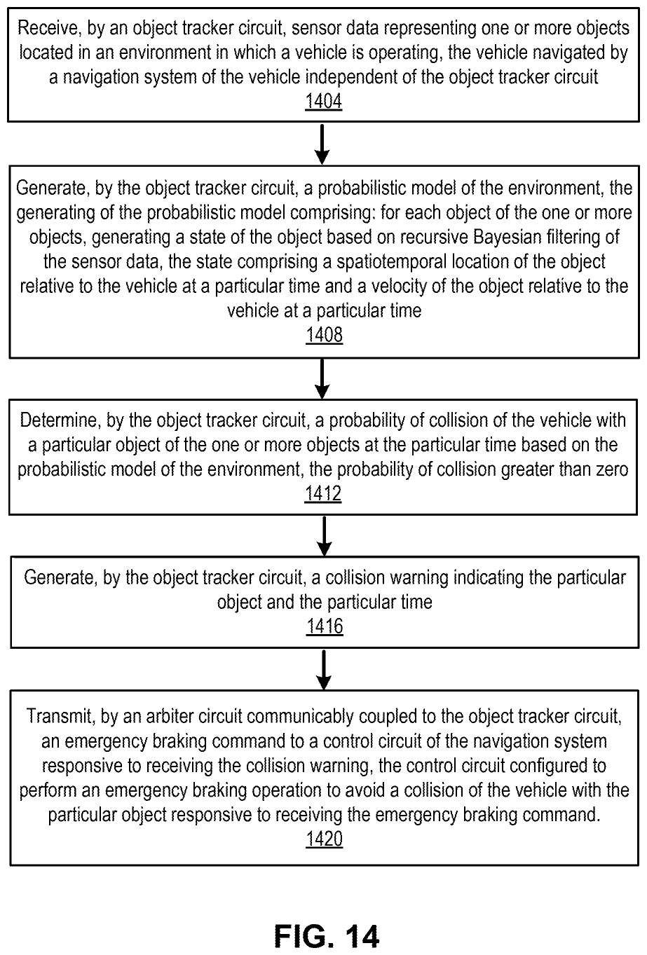

FIG. 14 is a flow diagram illustrating a process for operation of the safety system 1300, in accordance with one or more embodiments. In one embodiment, the process of FIG. 14 is performed by the safety system 1300. Other entities, for example, one or more components of the AV 100 perform one or more of the steps of the process in other embodiments. Likewise, embodiments may include different and/or additional steps, or perform the steps in different orders.

The safety system 1300 receives 1404 sensor data 1328 representing one or more objects 1304 located in an environment 190 in which the AV 100 is operating. The safety system 1300, sensor data 1328, and objects 1304 are illustrated and described in more detail with reference to FIG. 13. The AV 100 is guided by a navigation system 1308 of the AV 100 independent of the safety system 1300. The sensor data 1328 is generated by sensors 1324 of the AV 100 that include at least one of a RADAR or a camera. The sensors 1324 sense or measure properties of the environment 190. In an embodiments, the sensors 1324 are smart sensors that perform motion compensation relative to motion of the AV 100 based on odometry data 1334. For example, using data from wheel speed sensors and other odometry data 1334, the safety system 1300 performs lane position detection for the AV 100. The sensors 1324 generate sensor data 1328 (for example, RADAR signals or camera images) representing the properties of the environment 190.

The safety system 1300 generates 1408 a probabilistic model of the environment 190. The generating of the probabilistic model includes: for each object 1304, generating a probabilistic state of the object 1304. In some embodiments, recursive Bayesian filtering of the sensor data 1328 is used to generate the probabilistic state of the object 1304. In other embodiments, other probabilistic approaches are used to populate the dynamic occupancy grid using the dynamic occupancy grid circuit 1316, illustrated and described in more detail with reference to FIG. 13. The probabilistic state includes a spatiotemporal location of the object 1304 relative to the AV 100 at a particular time T and a velocity of the object 1304 relative to the AV 100 at the particular time T.

To generate the probabilistic model, the object tracker circuit 1312 generates the probabilistic state of each object 1304 based on recursive Bayesian filtering of the sensor data 1328. The object tracker circuit 1312 determines the probabilities of multiple “beliefs” (locations of the particular object 1304 and the AV 100) to allow the AV 100 to infer its position and orientation based on the sensor data 1328. In an embodiment, the sensor data 1328 is linearly distributed and the object tracker circuit 1312 performs the recursive Bayesian filtering using a Kalman filter. The Kalman filter uses the sensor data 1328 observed over time to produce estimates of the probabilistic state of each object 1304, such that the estimates are more accurate than those based on a single measurement alone.

In an embodiment, the safety system 1300 determines 1412 a first probability of collision of the AV 100 with a particular object 1304a of the one or more objects 1304 at the particular time T based on the probabilistic model of the environment 190. The first probability of collision is greater than zero. In an embodiment, the object tracker circuit 1312 is further configured to receive a trajectory 198 of the AV 100 from the navigation system 1308 via a connectivity circuit 1332. The safety system 1300 is independent of but communicates with the navigation system 1308 and its control software development kits (SDKs) via the connectivity circuit 1332 that carries the data traffic, and also compresses and decompresses or encrypts messages between the safety system 1300 and the navigation system 1308. The object tracker circuit 1312 determines the first probability of collision based on the trajectory 198. For example, the probabilistic model of the environment 190 is used to determine whether the particular object 1304a intersects with the trajectory 198 to predict a collision with the AV 100.

The safety system 1300 generates 1416 a first collision warning indicating the particular object 1304a and the particular time T. The arbiter circuit 1320 is communicably coupled to the object tracker circuit 1312 to receive signals, such as a heartbeat signal and the first collision warning from the object tracker circuit 1312, as illustrated and described in more detail with reference to FIG. 13.

The safety system 1300 transmits 1420 an emergency braking command to a control circuit 406 of the navigation system 1308, responsive to receiving the first collision warning. The control circuit 406 is illustrated and described in more detail with reference to FIGS. 4 and 13. The control circuit 406 is configured to perform an emergency braking operation to avoid a collision of the AV 100 with the particular object 1304a, responsive to receiving the emergency braking command, as illustrated and described in more detail with reference to FIG. 13.

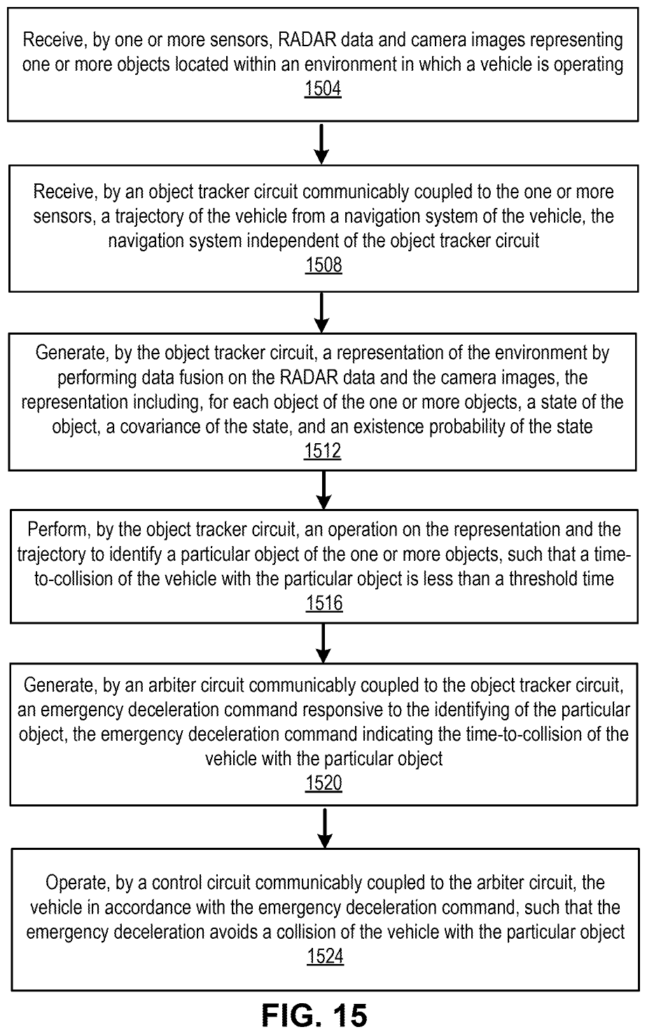

FIG. 15 is a flow diagram illustrating operation of the safety system 1300, in accordance with one or more embodiments. In one embodiment, the process of FIG. 15 is performed by the safety system 1300. Other entities, for example, one or more components of the AV 100 perform one or more of the steps of the process in other embodiments. Likewise, embodiments may include different and/or additional steps, or perform the steps in different orders.

The safety system 1300 receives 1504 RADAR data and camera images representing one or more objects 1304 located within an environment 190 in which the AV 100 is operating. The RADAR data and camera images are generated by the sensors 1324 of the AV 100. The sensors 1324 sense or measure properties of the environment 190. In an embodiments, the sensors 1324 are smart sensors that perform motion compensation relative to motion of the AV 100 based on odometry data 1334.

The safety system 1300 receives 1508 a trajectory 198 of the AV 100 from a navigation system 1308 of the AV 100. The AV 100 is guided by the navigation system 1308 independently of the safety system 1300. Among other components, the navigation system 1308 includes the perception module 402, the planning module 404, and the control circuit 406, illustrated and described in more detail with reference to FIG. 4.

The safety system 1300 generates 1512 a representation (probabilistic model) of the environment 190 by performing data fusion on the RADAR data, LiDAR data from the LiDAR 123, and the camera images (sensor data 1328). The probabilistic model of the environment 190 includes, for each object 1304, the probabilistic state of the object 1304, an error covariance P of the probabilistic state, and an existence probability p(x) of the state. The error covariance P refers to the joint variability of (a) the measurements of the object 1304 from the sensor data 1328 and (b) the probabilistic state of the object 1304. The existence probability p(x) refers to a function whose value at any given sample in the sample space provides a likelihood that the probabilistic state of the object 1304 equals that sample.

The safety system 1300 performs 1516 an operation (such as a matrix operation) on the representation (probabilistic model) of the environment 190 and the trajectory 198 to identify a particular object 1304a of the one or more objects 1304, such that a TTC of the AV 100 with the particular object 1304a is less than a threshold time. For example, the threshold time can be three or four seconds. The TTC determinations are performed with respect to the front bumper of the AV 100.

The safety system 1300 generates 1520 an emergency braking command, responsive to the identifying of the particular object 1304a. The emergency braking command indicates the TTC of the AV 100 with the particular object 1304a. The safety system 1300 is further configured to transmit the emergency braking command to the navigation system 1308, such that the navigation system 1308 is enabled to generate a new trajectory for the AV 100. The new trajectory is required because the current trajectory 198 resulted in the emergency braking command. In generating the new trajectory, the planning module 404 can steer away from the objects 1304, as illustrated and described in more detail with reference to FIG. 9.

A control circuit 406 is communicably coupled to the safety system 1300 and operates 1524 the AV 100 in accordance with the emergency braking command, such that the emergency deceleration avoids a collision of the AV 100 with the particular object 1304a.

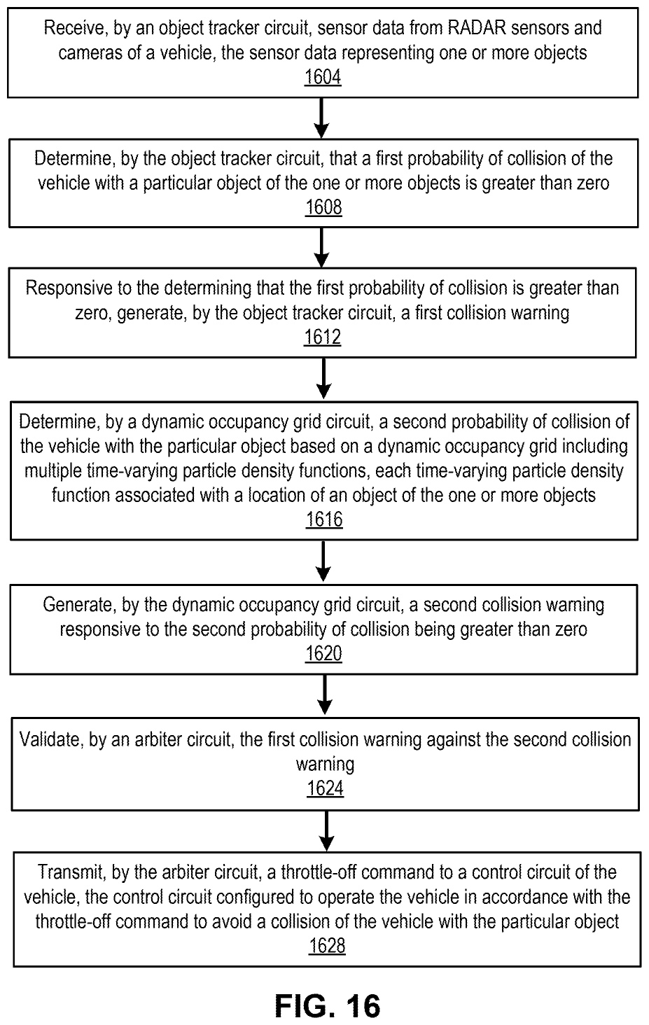

FIG. 16 is a flow diagram illustrating a process for operation of the safety system 1300, in accordance with one or more embodiments. In one embodiment, the process of FIG. 16 is performed by the safety system 1300. Other entities, for example, one or more components of the AV 100 perform one or more of the steps of the process in other embodiments. Likewise, embodiments may include different and/or additional steps, or perform the steps in different orders.

The safety system 1300 receives 1604 sensor data 1328 from one or more RADAR sensors and one or more cameras of the AV 100. The sensor data 1328 represents one or more objects 1304. The sensors 1324 sense or measure properties of the environment 190. In an embodiments, the sensors 1324 are smart sensors that perform motion compensation relative to motion of the AV 100 based on odometry data 1334. For example, using data from wheel speed sensors and other odometry data 1334, the safety system 1300 performs lane position detection for the AV 100.

The safety system 1300 determines 1608 that a first probability of collision of the AV 100 with a particular object 1304a of the one or more objects 1304 is greater than zero. In an embodiment, the safety system 1300 is configured to receive a trajectory 198 of the AV 100 from the navigation system 1308 via a connectivity circuit 1332. The safety system 1300 is independent of but communicates with the navigation system 1308 (and its control SDKs) via the connectivity circuit 1332 that carries the data traffic, and also compresses and decompresses or encrypts messages between the safety system 1300 and the navigation system 1308. The safety system 1300 determines the first probability of collision based on the trajectory 198. For example, a probabilistic model of the environment 190 is used to determine whether the particular object 1304a intersects with the trajectory 198 to predict a collision with the AV 100.

Responsive to the determining that the first probability of collision is greater than zero, the safety system 1300 generates 1612 a first collision warning. In some embodiments, the first collision warning indicates an identity of the particular object 1304a, a first TTC, and locations of the AV 100 and the particular object 1304a. In other embodiments, the throttle off perform a “throttle-off” step to prepare the AV 100 for deceleration. The throttle-off operation decreases the distance needed to stop the AV 100 since the brakes 103 will not contend with the throttle. The brakes 103 are illustrated and described in more detail with reference to FIG. 1. In some embodiments, the first collision warning is used to prepare the cabin of the AV 100 for a possible collision, such as by pre-tensioning seat-belts, preparing air bags for activation, winding up windows, angling headrests for safety, or moving seats away from doors, etc.

The safety system 1300 determines 1616 a second probability of collision of the AV 100 with the particular object 1304a based on a dynamic occupancy grid, including multiple time-varying particle density functions. Each time-varying particle density function is associated with a location of an object 1304. The dynamic occupancy grid refers to a discretized representation of the environment 190 of the AV 100. The dynamic occupancy grid includes a grid map with multiple individual cells (cubes) that each represents a unit area (or volume) of the environment 190.

The safety system 1300 generates 1620 a second collision warning, responsive to the second probability of collision being greater than zero. The second collision warning indicates the identity of the particular object 1304a, a second TTC, and locations of the AV 100 and the particular object 1304a based on the dynamic occupancy grid. The second TTC can be the same as the first TTC.

The safety system 1300 validates 1624 the first collision warning against the second collision warning. The safety system 1300 includes the object tracker circuit 1312 (for multi-object tracking) and the dynamic occupancy grid circuit 1316 as redundant collision warning systems that receive the raw sensor data 1328 and control data from the control circuit 406 independent of the navigation system 1308. The object tracker circuit 1312 and the dynamic occupancy grid circuit 1316 make independent decisions on whether to deaccelerate the AV 100.

The safety system 1300 transmits 1628 a throttle-off command to the control circuit 406 of the AV 100. The control circuit 406 is configured to operate the AV 100 in accordance with the throttle-off command to avoid a collision of the AV 100 with the particular object 1304a. The safety system 1300 issues commands to the control circuit 406 in the following order: throttle-off, seat belt pretension (if available on the AV 100 platform), brake pre-charge, emergency braking command, record internal black box data command, emergency flashing lights command. The brake deceleration by the safety system 1300 brings the AV 100 to a stop. The safety system 1300 maintains the pressure on the brakes 103 to keep the AV 100 stationary.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

What is claimed is:

1. A safety system for a vehicle, the safety system comprising:
an object tracker circuit configured to:
receive sensor data representing one or more objects located in an environment in which the vehicle is operating, the vehicle operated by a navigation system of the vehicle independent of the safety system;
generate a probabilistic model of the environment, the generating of the probabilistic model comprising:
for each object of the one or more objects, generating a state of the object based on recursive Bayesian filtering of the sensor data, the state comprising a spatiotemporal location of the object relative to the vehicle at a particular time and a velocity of the object relative to the vehicle at the particular time;
determine whether a probability of collision of the vehicle with a particular object of the one or more objects at the particular time based on the probabilistic model of the environment is greater than zero; and
generate a collision warning indicating the particular object and the particular time; and
an arbiter circuit communicably coupled to the object tracker circuit and configured to transmit an emergency braking command to a control circuit of the navigation system responsive to receiving the collision warning, the control circuit configured to perform an emergency braking operation to avoid a collision of the vehicle with the particular object responsive to receiving the emergency braking command.

2. The safety system of claim 1, wherein the arbiter circuit is further configured to verify the collision warning against a second probability of collision determined by a dynamic occupancy grid circuit of the safety system, the determining of the second probability of collision based on the sensor data, the transmitting of the emergency braking command to the control circuit performed responsive to the verifying of the second probability of collision.

3. The safety system of claim 1, wherein the sensor data is linearly distributed and the object tracker circuit performs the recursive Bayesian filtering using a Kalman filter.

4. The safety system of claim 1, wherein the generating of the probabilistic model of the environment is performed using object-based modeling in which the state of each object of the one or more objects is independent of the state of another object of the one or more objects.

5. The safety system of claim 1, wherein the object tracker circuit is further configured to receive a trajectory of the vehicle from the navigation system via a connectivity circuit, the determining of the probability of collision further based on the trajectory.

6. The safety system of claim 1, wherein the object tracker circuit is further configured to determine the spatiotemporal location and the velocity of the object using Cartesian coordinates.

7. The safety system of claim 1, wherein the probabilistic model of the environment comprises a Cartesian acceleration of the object relative to the vehicle.

8. The safety system of claim 1, wherein the object tracker circuit is configured to generate the state of the object by estimating a binary existence probability of the object using a binary Bayes filter.

9. The safety system of claim 1, wherein the object tracker circuit is configured to generate the state of the object by estimating a Mahalanobis distance between the state of the object and the sensor data.

10. The safety system of claim 1, wherein the performing of the emergency braking operation comprises turning off a throttle of the vehicle.

11. The safety system of claim 10, wherein the performing of the emergency braking operation comprises increasing a tension in one or more seat belts of the vehicle.

12. The safety system of claim 1, wherein the performing of the emergency braking operation comprises pre-charging brakes of the vehicle.

13. The safety system of claim 1, wherein the performing of the emergency braking operation comprises recording vehicle data by a black box of the vehicle.

14. The safety system of claim 1, wherein the performing of the emergency braking operation comprises turning on emergency flashing lights of the vehicle.

15. The safety system of claim 1, wherein the performing of the emergency braking operation comprises maintaining a brake pressure on brakes of the vehicle.

16. The safety system of any one of claim 1, wherein the control circuit is configured to perform the emergency braking operation to avoid blocking an intersection by the vehicle.

17. One or more non-transitory storage media storing instructions which, when executed by one or more computing devices, cause the one or more computing devices to:
receive sensor data representing one or more objects located in an environment in which a vehicle is operating, the vehicle operated by a navigation system of the vehicle independent of the one or more computing devices;
generate a probabilistic model of the environment, the generating of the probabilistic model comprising:
for each object of the one or more objects, generating a state of the object based on recursive Bayesian filtering of the sensor data, the state comprising a spatiotemporal location of the object relative to the vehicle at a particular time and a velocity of the object relative to the vehicle at the particular time;
determine whether a probability of collision of the vehicle with a particular object of the one or more objects at the particular time based on the probabilistic model of the environment is greater than zero;
generate a collision warning indicating the particular object and the particular time; and
transmit an emergency braking command to a control circuit of the navigation system responsive to receiving the collision warning, the control circuit configured to perform an emergency braking operation to avoid a collision of the vehicle with the particular object responsive to receiving the emergency braking command.

18. A method comprising:
receiving, by a safety system of a vehicle, sensor data representing one or more objects located in an environment in which the vehicle is operating, the vehicle operated by a navigation system of the vehicle independent of the safety system;
generating, by the safety system, a probabilistic model of the environment, the generating of the probabilistic model comprising:
for each object of the one or more objects, generating, by the safety system, a state of the object based on recursive Bayesian filtering of the sensor data, the state comprising a spatiotemporal location of the object relative to the vehicle at a particular time and a velocity of the object relative to the vehicle at the particular time;
determining, by the safety system, whether a probability of collision of the vehicle with a particular object of the one or more objects at the particular time based on the probabilistic model of the environment is greater than zero;
generating, by the safety system, a collision warning indicating the particular object and the particular time; and
transmitting an emergency braking command to a control circuit of the navigation system responsive to receiving the collision warning, the control circuit configured to perform an emergency braking operation to avoid a collision of the vehicle with the particular object responsive to receiving the emergency braking command.

19. The method of claim 18, further comprising verifying, by the safety system, the collision warning against a second probability of collision determined by a dynamic occupancy grid circuit of the safety system, the determining of the second probability of collision based on the sensor data, the transmitting of the emergency braking command to the control circuit performed responsive to the verifying of the second probability of collision

20. The method of claim 18, wherein the sensor data is linearly distributed and the object tracker circuit performs the recursive Bayesian filtering using a Kalman filter.
